(19) United States
(12) Patent Application Publication
(10) Pub. No.: US 2011/0197079 A1
(43) Pub. Date: Aug. 11, 2011

(54) PERIPHERAL DEVICE AND METHOD OF OPERATING THE SAME

(75) Inventor: Taichi EJIRI, Nagoya (JP)

(73) Assignee: BUFFALO INC., Nagoya-shi (JP)

(21) Appl. No.: 13/022,514

(22) Filed: Feb. 7, 2011

(30) Foreign Application Priority Data
Feb. 9, 2010 (JP) 2010-26624

(51) Int. Cl. G06F 1/26

(52) U.S. Cl. 713/300

(57) ABSTRACT

In a peripheral device of the invention, a signal line monitor is activated to monitor the status of a signal line included in an external bus. In response to detection of signal absence on the signal line, the peripheral device stops power supply from the power supply device to a primary device. Power supply from the power supply device to the signal line monitor is maintained or stopped, in response to supply or stop of electric power via a power line included in the external bus. When there is no signal transmission via the external bus, power supply to the primary device is cut off. The cut-off of power supply via the power line in the external bus leads to the cut-off of even the power supply to the signal line monitor. This mechanism effectively reduces power consumption in the peripheral device connected with the external bus having the power line.

### CROSS REFERENCE TO RELATED APPLICATION

This application claims priority from Japanese application P2010-26624A filed on Feb. 9, 2010, the content of which is hereby incorporated by reference into this application.

### BACKGROUND

1. Field of the Invention

This invention relates to a peripheral device for sending and receiving signals via a bus, and a method of operating the peripheral device.

2. Description of the Related Art

In conventional applications, a peripheral device, such as a hard disk drive, a DVD drive, a scanner, or a portable media player, is connected to an external bus, e.g., universal system bus or USB, of a computer to send and receive information to and from the computer. Some external buses may be designed to include a power line for power supply to the connected peripheral device. The USB is a typical example of this type of external bus and has a power line VBUS in addition to signal lines D+ and D−.

A master device is generally expected to supply power to the power line included in this type of external bus. When the master device is a computer, however, the state transition of the power line may be varied according to the operating status of the computer. Especially in sleep mode, whether or not the computer maintains the power supply via the power line in the external bus, depends on what the model of the computer is. There has been a proposal that the operating condition of an externally connected device, for example, should determine how the power is supplied when the computer is in sleep mode (see, for example, Japanese Patent Laid-Open No. 2009-302831).

If an external bus having a power line is used, and if the peripheral device is so designed as to operate on electric power supplied via the power line, then convenience in using the peripheral device is enhanced. However, since there is a limit to the amount of electric power that can be supplied via the power line in the external bus (bus power), many peripheral devices have their own power supply systems. In many cases, power is supplied through the use of AC/DC adapters. In such cases, a design is required which makes it possible to select between the electric power supplied via the power line in the external bus and the electric power supplied from the AC/DC adapter.

Therefore, as to the peripheral device used in connection with the external bus having the power line, there is a requirement for successfully handling the complicated design issues to selectively use the power line in the external bus and the power line of its own power supply device and cover various relations of the statuses of the power line to the operating statuses of a device (for example, a computer) supplying electric power to the external bus.

Especially when the computer supplies electric power to the external bus and has a sleep mode of suspending the operation, it is required to handle the status of the power line in the external bus in the sleep mode. For, in sleep mode, some computers may stop the power supply to the power line, while other computers may maintain the power supply to the power line. In the latter case, the peripheral device designed to operate with electric power supplied via the power line in the external bus may continue its operating state to wastefully consume the electric power supplied from the computer. Such waste power consumption is a significant problem when the computer operates only on power from the battery.

### SUMMARY

This invention, which has been made to solve the problem mentioned above, can be realized in various embodiments and applications described below.

### Embodiment 1

A peripheral device which operates by being connected with an external bus including a signal line for information transmission and a power line for power supply, comprising:

a power supply device for supplying electric power for the peripheral device, separately from the electric power supplied through the power line of the external bus;

a primary device which operates by receiving electric power from the power supply device and processes information sent and received via the signal line;

a signal line monitor which monitors the status of the signal line of the external bus and which interrupts the power supply from the power supply device to the primary device when signal absence on the signal line is detected; and

a power supply control circuit which continues or interrupts the supply of electric power from the power supply device to the signal line monitor in response to the continuation or interruption of electric power supply via the power line of the external bus.

The peripheral device according to the first embodiment of the invention generally activates the signal line monitor to monitor the status of the signal line of the external bus. When no signal is detected on the signal line, the peripheral device stops power supply from the power supply device to a primary device. Power supply from the power supply device to the signal line monitor is continued or interrupted in response to the continuation or interruption of electric power supply via the power line included in the external bus. When there is no signal transmission via the external bus, power supply to the primary device is stopped. The loss of power supply via the power line of the external bus leads to the loss of the power supply to the signal line monitor, too. This mechanism effectively reduces wasted power consumption.

### Embodiment 2

A peripheral device according to the first embodiment described above, wherein the external bus is universal system bus or USB.

Adopting the USB as the external bus, the peripheral device of this embodiment can provide an extremely high versatility.

### Embodiment 3

A peripheral device according to the first or second embodiment described above, wherein the external bus is connected to a connector provided in a computer by means of a cable to communicate information with the computer.

The peripheral device of this embodiment communicates information with the computer while effectively reducing power consumption, irrespective of the operating status of the computer including a sleep mode.

### Embodiment 4

A peripheral device according to the first or third embodiment described above wherein the power supply control circuit includes field-effect transistors (FET); the drain-source paths of the FETs are placed in the circuit for power supply from the power supply device; and the on/off signal corresponding to the voltage on 1 the power line in the external bus is applied to the gate of the FET.

The peripheral device of this embodiment using the simple FET-based circuit structure can effectively cut off the power supply from the power supply device to the signal line monitor. The FET has a high cut-off resistance and thereby draws substantially zero leak current. Moreover, the FET hardly requires electric power to drive and also consumes very little power for the operation itself. The FET circuit may comprise combinations of FETs, each combination consisting of two FETs having different types of conduction channels. Signals applied to the gate of the FETs may be generated by different circuit elements such as transistors.

### Embodiment 5

A peripheral device according to the first through fourth embodiments described above, wherein the primary device is a storage device for non-volatile storage of information.

The peripheral device of this embodiment can store information in a non-volatile manner. Even when power supply is interrupted, the peripheral device can continue to store information and allow for flexible power control according to the status of the external bus. Typical examples of the storage device include a hard disk drive, an SSD drive adopting, for example, a flash memory, a DVD drive, an MO drive, and a CD drive. The storage device may be a DVD drive, a CD drive or a read-only storage, or alternatively even a storage rewritable once or multiple times. A memory card reader may also be used for the primary device.

### Embodiment 6

A peripheral device according to the fifth embodiment described above, wherein the signal line monitor has a CPU which sends and receives the information via the signal line of the external bus; and the CPU detects the absence of signal on the signal line and communicates the information with the storage device.

In the peripheral device of this embodiment, since the CPU which communicates the information with the storage device also functions as the signal line monitor, the overall structure of the peripheral device can be simplified.

### Embodiment 7

A method of operating a peripheral device connected to a computer via an external bus, comprising: activating a signal line monitor to monitor a status of a signal line included in the external bus; stopping power supply from a power supply device to a primary device, which is arranged and adapted to operate on electric power supplied from the power supply device, when a absence of signal input from the computer onto the signal line is detected; monitoring a power line included in the external bus and supplying or stopping electric power from the power supply device to the signal line monitor, in response to supply or stop of electric power via the power line; and supplying electric power from the power supply device to the primary device and causing the primary device to process information input via the signal line, when a signal is input from the computer via the signal line in the external bus.

According to the method of operating the peripheral device as set forth in this embodiment, the signal line monitor is usually operated to monitor the status of the signal line of the external bus; the power supply from the power supply device to a primary device is interrupted in response to the detection of signal absence on the signal line; and power supply from the power supply device to the signal line monitor is maintained or cut off in response to the supply or interruption of electric power via a power line included in the external bus. Accordingly, when there is no signal communication via the external bus, power supply to the primary device is cut off. Also, when power supply via the power line of the external bus is cut off, even the power supply to the signal line monitor is cut off. As a result, wasteful power consumption can be securely suppressed.

### Embodiment 8

A method of operating the peripheral device as set forth in the seventh embodiment described above, wherein even when the signal line monitor detects the absence of the signal from the computer on the signal line, the power supply from the power supply device to the primary device is continued until the completion of the operation of the primary device. The method of this embodiment assures the completion of the operation of the primary device.

### BRIEF DESCRIPTION OF THE DRAWINGS

FIG. 1 schematically shows the configuration of a hard disk drive as one embodiment of the peripheral device according to the invention;

FIG. 2 is a circuit diagram of the internal structure of the hard disk drive as the embodiment;

FIG. 3 is a flowchart showing the flow of a process executed by a controller installed in the hard disk drive;

FIG. 4 is an explanatory diagrammatic representation of one example of state transition of power consumption in the hard disk drive connected to a computer without sleep mode;

FIG. 5 is an explanatory diagrammatic representation of another example of state transition of power consumption in the hard disk drive connected to the computer without sleep mode; and

FIG. 6 is an explanatory diagrammatic representation of one example of state transition of power consumption in the hard disk drive connected to a computer with sleep mode.

### DESCRIPTION OF THE PREFERRED EMBODIMENTS

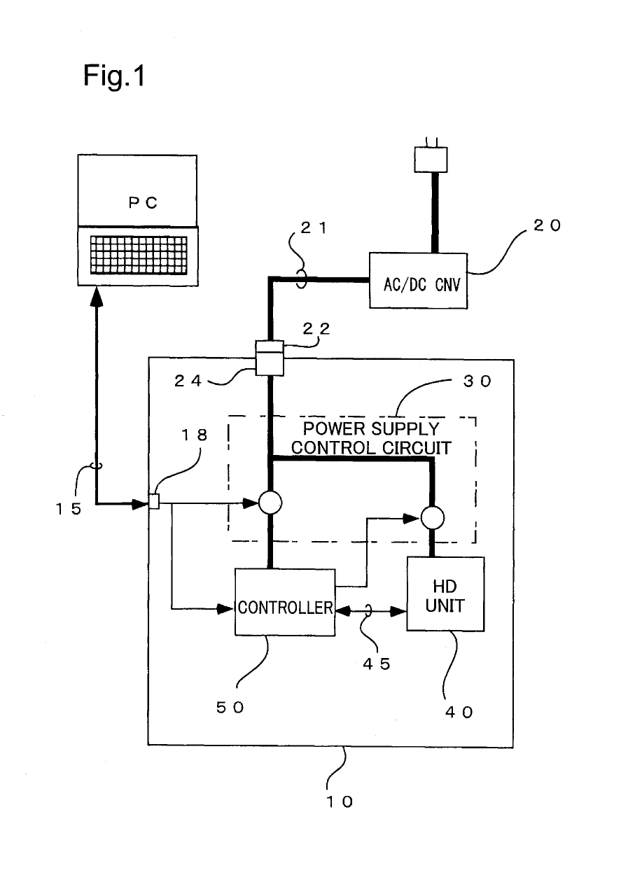

Embodiments of this invention will be described in detail below with reference to the attached drawings. FIG. 1 schematically shows configuration of a hard disk drive 10 as one embodiment of the peripheral device according to the invention. As illustrated, the hard disk drive 10 is connected to a computer PC by means of a USB cable 15. The USB cable 15 from the computer PC is attached to a USB connector 18 provided in the hard disk drive 10. The USB is a well-known universal external bus. The USB cable 15 has four lines, i.e., signal lines D+ and D− for sending and receiving e data by serial communication, a power line VBUS for supplying electric power of 5 volts, 500 milliamperes (mA), and a grounding conductor GND.

The hard disk drive 10 operates on electric power supplied from an AC adapter 20 that functions as an AC/DC converter for converting commercial AC (alternating current) into a DC (direct current) voltage of 12 volts. A plug 22 is provided at one end of a DC power cable 21 of the AC adapter 20 and is mated with a power connector 24 of the hard disk drive 10. A power line for 12-volt DC extends from the power connector 24 and is laid out inside the hard disk drive 10 to supply electric power to a power supply control circuit 30. The power supply control circuit 30 further generates an electric power of 5-volt DC. The details of the structure and the functions of the power supply control circuit 30 will be described later.

The hard disk drive 10 further includes a hard disk unit (hereafter referred to as HD unit) for magnetically storing data and a controller 50 for overall control of the hard disk drive 10, in addition to the power control circuit 30. The HD unit 40 complies with the SATA (serial ATA) standard and receives signals of the SATA standard via an internal bus 45 of the SATA standard and write data extracted from the received SATA signals into an internal magnetic disk or read out data from the magnetic disk.

The controller 50 has an internal microcomputer and mainly performs the following three processes:

(A) The controller 50 is connected to signal lines D+ and D− of the USB connector 18 to read signals from these signal lines D+ and D− and control data transmission to and from the computer PC;

(B) The controller 50 is connected to the HD unit 40 of the SATA (serial ATA) standard via the internal bus 45 of the SATA standard to process signals on the internal SATA bus 45 and control data transmission to and from the HD unit 40; and

(C) The controller 50 is connected to a power line VBUS of the USB connector 18 to control switching elements in the power supply control circuit 30 in response to the status of the power line VBUS.

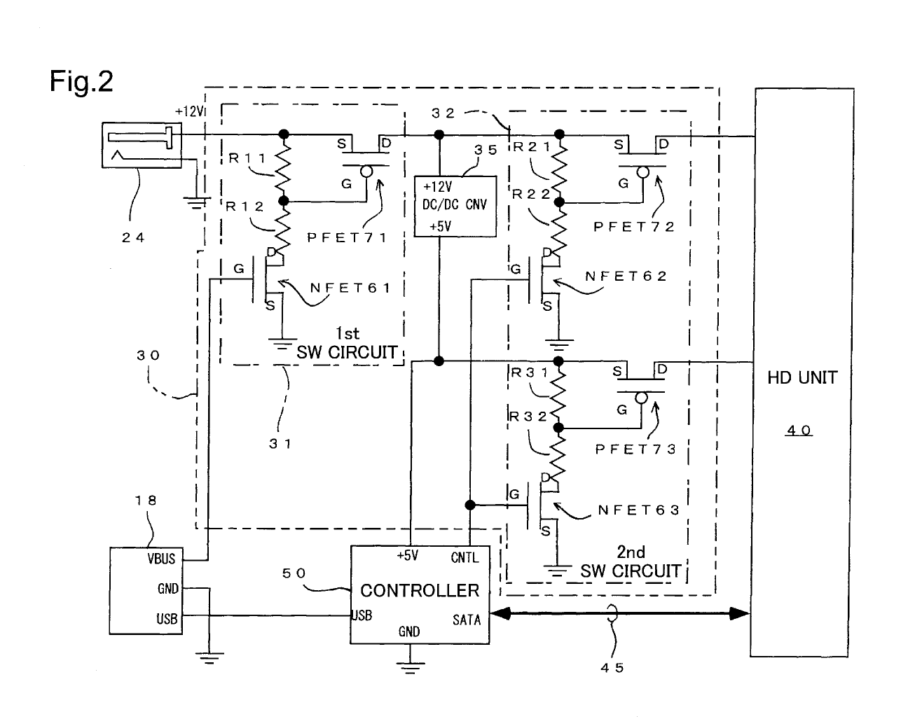

The internal structure of the power supply control circuit 30 is described with reference to FIG. 2. The power supply control circuit 30 includes a first switching circuit (hereafter referred to as 1st SW circuit) 31, a second switching circuit (hereafter referred to as 2nd SW circuit) 32, and a DC/DC converter 35 as shown in FIG. 2. The DC/DC converter 35 generates a 5-volt DC power from the 12-volt DC supplied from the AC adapter 20. The 5-volt DC power is used by the controller 50 and the HD unit 40.

As shown in FIG. 2, the 1st SW circuit 31 includes an N channel field-effect transistor (hereafter referred to as NFET) 61, a P channel field-effect transistor (hereafter referred to as PFET) 71, and a voltage divider consisting of resistors R11 and R12. The gate G of the NFET 61 is connected with the power line VBUS of the USB connector 18. The drain D of the NFET 61 receives a DC voltage of 12-volt via the voltage divider R11 and R12. The source S of the NFET 61 is grounded. Therefore, while power is being supplied through the power line VBUS of the USB connector 18, the supplied voltage keeps the NFET 61 conductive, i.e. establishes conductive channel between the drain D and the source S of the NFET 61. This subsequently turns on the PFET 71 having its gate G connected to the junction point of the voltage dividing resistors R11 and R12, to establish conductive channel between a source S and a drain D of the PFET 71. The turn-on resistance of the field-effect transistor is generally about zero, so that the 12-volt DC supplied to the power connector 24 is outputted with substantially no change in voltage level to the DC/DC converter 35 and to the 2nd SW circuit 32. This triggers the operation of the DC/DC converter 35 to supply the 5-volt DC to the controller 50.

The 2nd SW circuit 32 has two switching circuits each of which includes field-effect transistors similar to those incorporated in the 1st SW circuit 31 described above. The respective gates G of NFETs 62 and 63 in the two switching circuits receive a control signal CNTL from the controller 50. The source S of a PFET 72 is connected to the power line of the 12-volt DC output from the 1st SW circuit 31 while the source S of a PFET 73 is connected to the power line of the 5-volt DC output from the DC/DC converter 35. Accordingly, when the control signal CNTL from the controller 50 takes an “active” level, the two PFETs 72 and 73 in the 2nd SW circuit 32 are both turned conductive to respectively supply the 12-volt DC and the 5-volt DC to the HD unit 40.

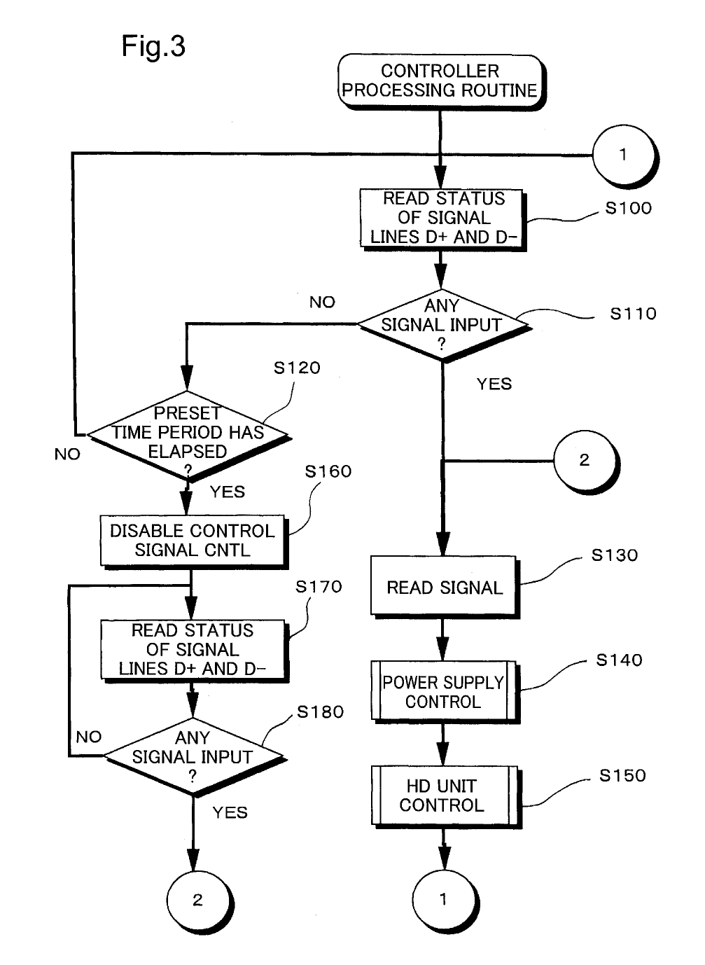

The operations of the controller 50 are explained. FIG. 3 is a flowchart showing a process flow followed by the microcomputer incorporated in the controller 50. As shown in FIG. 3, the controller 50 is activated when the 1st SW circuit 31 is driven to supply the 12-volt DC to the DC/DC converter 35, and subsequently when the DC/DC converter 35 outputs the 5-volt DC to the controller 50. The controller 50 first reads the statuses of the signal lines D+ and D− of the USB connector 18 (step S100) and checks whether or not there are signals on the USB signal lines D+ and D− (step S110). In the absence of any signal on the USB signal lines D+ and D−, the controller 50 checks whether a preset time has elapsed (step S120). Until the preset time has elapsed, the reading of the statuses the signal lines D+ and D− (step S100) and the detection of signals (step S110) are repeated.

Upon detection of any signal on the USB signal lines D+ and D− before the elapse of the preset time (steps S100 and S110), the controller 50 reads the signal (step S130) and then performs power supply control (step S140) and HD unit control (step S150). The power supply control process (step S140) is that process which, if the control signal CNTL was absent due to the absence of signals on the signal lines D+ and D−, causes the control signal CNTL to be changed to a high level (5 volts) and thereby turns both the PFETs 72 and 73 in the 2nd SW circuit 32 conductive. In addition, the power supply control process keeps the control signal CNTL at the high level if the control signal CNTL has already been at the high level. The HD unit control process is the process of recognizing that the signals on the USB signal lines D+ and D− represent data transmission to and from the HD unit 40 and writing the data into the HD unit 40 or reading data from the HD unit 40 according to the content of the data.

When there are no signals on the signal lines D+ and D− before the elapse of the preset time (steps S100, S110, and S120), on the other hand, the controller 50 determines that the USB as the external bus is not currently in use and does not output the control signal CNTL (step S160). This makes both the PFETs 72 and 73 in the 2nd SW circuit 32 nonconductive and cuts off the power supply to the HD unit 40.

The controller 50 subsequently reads the statuses of the signal lines D+ and D− of the USB connector 18 (step S170) and detects any signals on the USB signal lines D+ and D− (step S180). The reading of the signal lines D+ and D− (step S170) and the detection of signals input (step S180) are repeated until signals are delivered onto the USB signal lines D+ and D−. Upon detection of signals on the USB signal lines D+ and D−, the processing flow proceeds to step S130 of reading the signals on the signal lines D+ and D− and subsequent steps. On completion of the reading of the signals on the signal lines D+ and D− (step S130), the power supply control (step S140) and the HD unit control (step S150) described above, the process flow goes back to step S100 to repeat the series of steps described above.

The hard disk drive 10 of the embodiment adopting the circuit structure (FIG. 2) described above and the above series of processing steps (FIG. 3) executed by the controller 50 performes the following operations.

(1) In the case where the computer PC connected via the USB cable 15 is active and supplies electric power via the power line VBUS:

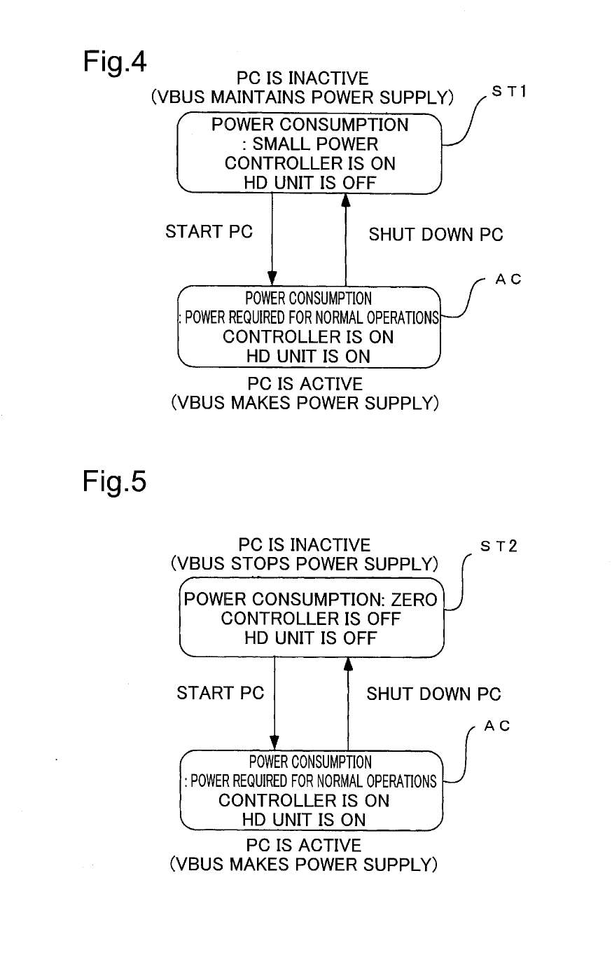

The PFET 71 of the 1st SW circuit 31 is turned conductive, and the DC/DC converter 35 starts its operation. In response to the application of signals to the USB signal lines D+ and D−, the controller 50 of the hard disk drive 10 outputs the control signal CNTL to turn on both the PFETs 72 and 73 in the 2nd SW circuit 32 conductive. This triggers the operation of the HD unit 40. The hard disk drive 10 sends and receives data to and from the computer PC and writes or reads required data into or from the HD unit 40. This state is shown as a status AC in FIG. 4. In the status AC, the hard disk drive 10 receives and consumes electric power required for the normal operations from the AC adapter 20.

(2) In the case where the computer PC connected via the USB cable 15 is inactive but maintains the power supply via the power line VBUS:

The PFET 71 of the 1st SW circuit 31 is turned conductive, and the DC/DC converter 35 performs the operation. Since the computer PC is inactive, there are no signals delivered onto the USB signal lines D+ and D−. The controller 50 of the hard disk drive 10 accordingly does not output the control signal CNTL so that both the PFETs 72 and 73 in the 2nd SW circuit 32 remain nonconductive. This stops the operation of the HD unit 40. The hard disk drive 10 hardly consumes power. The DC/DC converter 35 and the controller 50 operate and consume a small amount of electric power. This state is shown as status ST1 in FIG. 4.

(3) In the case where the computer PC connected via the USB cable 15 is inactive and also stops the power supply via the power line VBUS:

The PFET 71 of the 1st SW circuit 31 remains nonconductive, and the DC/DC converter 35 stops the operation. This stops the operation of the controller 50 and keeps both the PFETs 72 and 73 in the 2nd SW circuit 32 nonconductive. The HD unit 40, the DC/DC converter 35, and the controller 50 all stop the operations. The hard disk drive 10 accordingly consumes no power. This state is shown as status ST2 in FIG. 5.

(4) In the case where the computer PC connected via the USB cable 15 is in sleep mode but maintains the power supply via the power line VBUS:

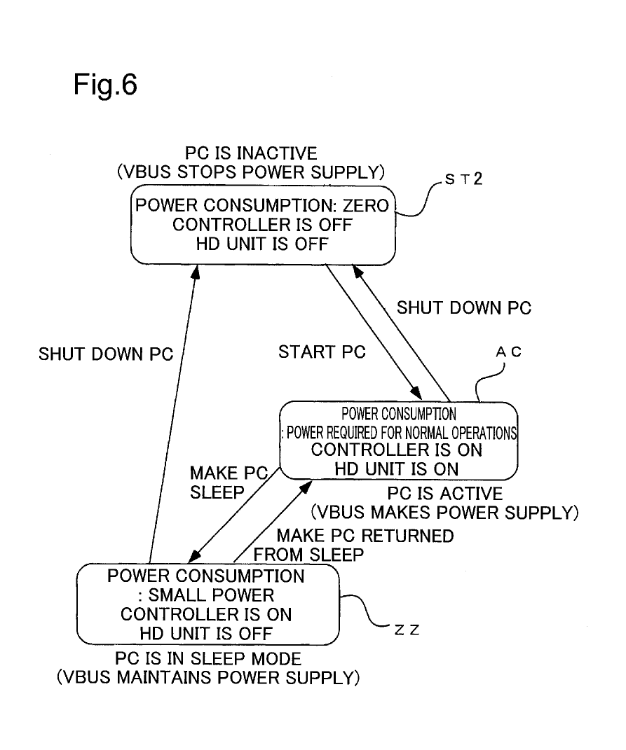

This state is equivalent to the status ST1 of the case (1) described above and is shown as status ZZ in FIG. 6.

(5) In the case where the computer PC connected via the USB cable 15 is in sleep mode and also stops the power supply via the power line VBUS:

This state is equivalent to the status ST2 of the case (3) described above.

Examples of state transition described above are summarized in FIGS. 4 through 6. FIG. 4 is an explanatory diagrammatic representation of the state of power consumption when the computer PC changes its state between the case (1) and the case (2) described above, that is, state transition occurs between the status AC and the status ST1. FIG. 5 is an explanatory diagrammatic representation of the state of power consumption when the computer PC changes its state between the case (1) and the case (3) described above, that is, state transition occurs between the status AC and the status ST2. FIG. 6 is an explanatory diagrammatic representation of the state of power consumption when the computer PC changes its state among the case (1), the case (3), and the case (4) described above, that is, state transition occurs among the status AC, the status ST2, and the status ZZ.

While the computer PC is inactive or is in sleep mode, the hard disk drive 10 as one peripheral device of the computer PC does not consume the electric power supplied by the computer PC, irrespective of the state of the power line VBUS of the USB bus. The power consumption by the hard disk drive 10 can be reduced to either zero or such a low level that only the DC/DC converter 35 and the controller 50 can operate. The computer PC in sleep mode may be required to return from the sleep mode within a short time period. In this case, since the controller 50 continues monitoring the status of the signal lines D+ and D−, the controller 50 is able to detect a restart of the computer PC immediately and activate the HD unit 40.

Thus, the hard disk drive 10 of the embodiment can suppress wasteful power consumption and realize operations of the high response. The 1st SW circuit 31 and the 2nd SW circuit 32 included in the power supply control circuit 30 adopt the field-effect transistors. This configuration enables the consumption of the power supplied through the USB for the operations of the field-effect transistors to be minimized (to substantially zero). Therefore, even when the computer PC is being operated by the battery power, is in sleep mode, and still maintains the power supply to the power line VBUS of the USB, the battery of the computer PC is not used up by the hard disk drive 10 connected to the USB.

In the foregoing, the configuration in which the hard disk drive 10 is used as a peripheral device has been described. Such peripheral devices, however, can include various devices such as, for example, other storage devices, scanners, media players, or sound input or output devices. Further, the external bus is not restricted to the USB but may be any of other various buses, such as HDML.

The above description of the embodiment does not refer to a semiconductor memory such as a RAM. The device for non-volatile recording such as the hard disk drive may incorporate therein e a semiconductor memory for temporary data storage as a buffer. The buffer has the high-speed writing capability and thus increases the apparent writing speed of the hard disk drive in comparison with the operating speed of the computer PC. The hard disk drive equipped with the buffer may not stop the power supply to the HD unit 40 immediately after the detection of the absence of signals on the USB signal lines D+ and D−, but may interrupt the control signal CNTL after a delay equal to the time required for writing data from the buffer to the HD unit 40. This configuration is useful in effectively assuring the data writing. Immediately before the computer PC falls into sleep mode or stops its operation, a certain command, such as ‘cache flush’, may be sent from the computer PC to the hard disk drive to forcibly write data stored in the buffer into the HD unit 40.

In the embodiment described above, the internal controller 50 of the microcomputer detects the signals delivered onto the USB signal lines D+ and D−. A discrete circuit may perform such detection. In the embodiment described above, in the state where the computer PC is in sleep mode while the power supply to the power line VBUS is being maintained, the controller 50 repeats the reading of the signal lines D+ and D− (step S170) and the check (step S180). One modified procedure may be to stop the operation of the controller 50 for a predetermined time period after each detection operation by the controller 50. This modification further reduces power consumption by the hard disk drive 10.

The embodiment of the invention and its modifications are described above. The embodiment and its modifications discussed above are to be considered in all aspects as illustrative and not restrictive. There may be many other modifications, changes, and alterations without departing from the scope or spirit of the present invention.

What is claimed is:

1. A peripheral device which operates by being connected with an external bus including a signal line for information transmission and a power line for power supply, comprising:
a power supply device for supplying electric power for the peripheral device, separately from the electric power supplied through the power line of the external bus;
a primary device which operates by receiving electric power from the power supply device and processes information sent and received via the signal line;
a signal line monitor which monitors the status of the signal line of the external bus and which interrupts the power supply from the power supply device to the primary device when signal absence on the signal line is detected; and
a power supply control circuit which continues or interrupts the supply of electric power from the power supply device to the signal line monitor in response to the continuation or interruption of electric power supply via the power line of the external bus.

2. A peripheral device according to claim 1, wherein the external bus is universal system bus or USB.

3. A peripheral device according to claim 1, wherein the external bus is connected to a connector provided in a computer by means of a cable to communicate information with the computer.

4. A peripheral device according to claim 1, wherein the power supply control circuit includes field-effect transistors (FETs); the drain-source paths of the FETs are placed in the circuit for power supply from the power supply device; and the on/off signal corresponding to the voltage on the power line of the external bus is applied to the gate of the FET.

5. A peripheral device according to claim 1, wherein the primary device is a storage device for non-volatile storage of information.

6. A peripheral device according to claim 5, wherein the signal line monitor has a CPU which sends and receives the information via the signal line of the external bus; and the CPU detects the absence of signal on the signal line and communicates the information with the storage device.

7. A method of operating a peripheral device connected to a computer via an external bus, comprising:
activating a signal line monitor to monitor a status of a signal line included in the external bus;
stopping power supply from a power supply device to a primary device, which is arranged and adapted to operate on electric power supplied from the power supply device, when a absence of signal input from the computer onto the signal line is detected;
monitoring a power line included in the external bus and supplying or stopping electric power from the power supply device to the signal line monitor, in response to supply or stop of electric power via the power line; and
supplying electric power from the power supply device to the primary device and causing the primary device to process information input via the signal line, when a signal is input from the computer via the signal line in the external bus.

8. A method of operating the peripheral device according to claim 7, wherein even when the signal line monitor detects the absence of the signal from the computer on the signal line, the power supply from the power supply device to the primary device is continued until the completion of the operation of the primary device.
